(19) United States
(12) Patent Application Publication
(10) Pub. No.: US 2026/0303677 A1
(43) Pub. Date: Oct. 1, 2026

(54) METHOD AND SYSTEM FOR PAIRING A STREAM TO A USER

(71) Applicant: STINGRAY GROUP INC., Montreal (CA)

(72) Inventors: Philippe Cote, Montreal (CA); Etienne Houle, Montreal (CA); Jean-Sebastien Ruest, Montreal (CA); Eric Lariviere, Montreal (CA); Marc-Andre Lavigne, Montreal (CA)

(73) Assignee: STINGRAY GROUP INC., Montreal, QC (CA)

(21) Appl. No.: 19/163,318

(22) PCT Filed: Mar. 14, 2024
(86) PCT No.: PCT/IB2024/052503

§ 371 Date: Sep. 8, 2025

Related U.S. Application Data
(60) Provisional application No. 63/490,110, filed on Mar. 14, 2023.

(30) Foreign Application Priority Data
Mar. 14, 2024 (WO) PCT/IB2024/052503

(51) Int. Cl. H04L 65/611; H04L 65/75

(52) U.S. Cl. CPC H04L 65/611; H04L 65/75

(57) ABSTRACT

A method for pairing a user to a display device in an Over-The-Top broadcasting system, the method comprising: embedding unique identifiers into a plurality of streams, each one of the plurality of streams being associated with a respective one of the unique identifiers and with a respective one of a plurality of display devices; transmitting the plurality of streams to a plurality of display devices, each one of the plurality of streams being transmitted to a respective one of the plurality of display devices; receiving from a user device an indication of a given one of the unique identifiers; assigning a given one of the plurality of display devices that is associated with the given one of the unique identifiers to the user, thereby obtaining a pairing between the user and the given one of the plurality of display devices; and outputting the pairing.

### FIELD

The present technology pertains to the field of broadcasting. More specifically, the present technology pertains to Over-The-Top broadcasting and, in particular, to user pairing methods and to methods of content personalization.

### BACKGROUND

Conventional linear TV broadcasts follow a schedule set by the content provider, for example a TV broadcaster, and do not allow a user to access personalized content. Accordingly, the content of the broadcast, including advertisements, is preprogrammed for each channel and for each period of time by the content provider without user input.

All users sharing conventional TV broadcasts receive the same content substantially at the same time. For example, all users watching the same linear channel in a household will receive the same content. To change content, the user must change the selected channel to another channel having other preprogrammed content.

Growing demand and uptake of Over-The-Top (OTT) streaming has prompted content providers to create their own OTT platform. Over-the-Top streaming allows users to obtain content on demand not limited by a provider's preprogrammed content for a given period.

Some OTT channels may be live while other OTT channels may be on-demand. For example, Hypertext Transfer Protocol (HTTP) live-streaming (HLS) technology may be used to deliver live and on-demand content. Customizing content to a particular user relies on user credentials (for example account logins) or on connection data such as gateway IP addresses. These methods, however, do not ensure that the personalized content is delivered to the intended user.

There is therefore a need for improved pairing methods to pair streams to users. There is furthermore a need for device-agnostic pairing methods allowing to pair users to streams on a variety of display devices, playback devices and player software.

### SUMMARY

According to a first broad aspect, there is provided a method for pairing a user to a display device in an Over-The-Top broadcasting system, the method being executed by a processor, the method comprising: embedding unique identifiers into a plurality of streams, each one of the plurality of streams being associated with a respective one of the unique identifiers and with a respective one of a plurality of display devices; transmitting the plurality of streams to a plurality of display devices, each one of the plurality of streams being transmitted to a respective one of the plurality of display devices; receiving from a user device an indication of a given one of the unique identifiers; assigning a given one of the plurality of display devices that is associated with the given one of the unique identifiers to the user, thereby obtaining a pairing between the user and the given one of the plurality of display devices; and outputting the pairing.

According to a second broad aspect, there is provided a method of personalizing content delivery in an Over-The-Top broadcast system, the method being executed by a processor, the method comprising: embedding unique identifiers into a plurality of streams, each one of the plurality of streams being associated with a respective one of the unique identifiers and with a respective one of a plurality of display devices; transmitting the plurality of streams to a plurality of display devices, each one of the plurality of streams being transmitted to a respective one of the plurality of display devices; receiving from a user device an indication of a given one of the unique identifiers; assigning a given one of the plurality of display devices that is associated with the given one of the unique identifiers to the user, thereby obtaining a pairing between the user and the given one of the plurality of display devices; generating personalized content for the user; embedding the personalized content into a given one of the plurality of streams that is associated with the given one of the unique identifiers, thereby obtaining a personalized stream; and transmitting the personalized stream to the given one of the plurality of display devices.

In some embodiments, the method further comprises receiving a pairing request from the user device.

In some embodiments, the unique identifiers comprise one of barcodes, QR-codes, images, numbers, alphanumeric codes and sounds.

In some embodiments, the step of generating the personalized content comprises retrieving the personalized content associated with the user from a database.

In some embodiments, the step of generating personalized content comprises receiving, from the user device, an indication of predetermined content to be embedded in the given one of the plurality of streams.

In some embodiments, the step of embedding comprises replacing at least a portion of a content of the given one of the plurality of streams with the personalized content.

In some embodiments, the at least a portion of the content is one of predetermined and arbitrary.

In some embodiments, the step of embedding comprises inserting the personalized content between at least two portions of a content of the given one of the plurality of streams.

In some embodiments, the method further comprises generating the unique identifiers.

In some embodiments, the method further comprises retrieving the unique identifiers from a database containing pre-generated unique identifiers.

According to another broad aspect, there is provided a method of personalizing content delivery in an Over-The-Top broadcast system, the method being executed by a processor, the method comprising: embedding unique identifiers into a plurality of streams, each one of the plurality of streams being associated at a given time with a respective one of the unique identifiers and with a respective one of a plurality of display devices; transmitting the plurality of streams, each one of the plurality of streams being transmitted to a respective one of the plurality of display devices; receiving from a user device an indication of a given one of the unique identifiers; assigning, to the user, a given one of the plurality of streams that corresponds to: the given one of the unique identifiers; and the given time at which the given one of the unique identifiers had been embedded into a respective one of the plurality of streams, thereby obtaining a pairing between the given one of the plurality of streams and the user; and outputting the pairing.

embodiments, the method further comprises: generating personalized content for the user; embedding the personalized content into the given one of the plurality of streams, thereby obtaining a personalized stream; transmitting the personalized stream to a given one of the plurality of display devices that is associated with the given one of the unique identifiers.

In some embodiments, the method further comprises receiving a pairing request from the user device.

In some embodiments, the unique identifiers comprise one of barcodes, QR-codes, images, numbers, alphanumeric codes and sounds.

In some embodiments, the step of generating personalized content comprises retrieving the personalized content associated with the user from a database.

In some embodiments, the step of generating personalized content comprises receiving, from the user device, an indication of predetermined content to be embedded in the given one of the plurality of streams.

In some embodiments, the step of embedding comprises replacing at least a portion of a content of the given one of the plurality of streams with the personalized content.

In some embodiments, the at least a portion of the content is one of predetermined and arbitrary.

In some embodiments, the step of embedding comprises inserting the personalized content between at least two portions of a content of the given one of the plurality of streams.

In some embodiments, the method further comprises generating the unique identifiers.

In some embodiments, the method further comprises retrieving the unique identifiers from a database containing pre-generated unique identifiers.

According to a further broad aspect, there is provided a system for pairing a user to a display device in an Over-The-Top broadcasting system, the system comprising: a processor; a non-transitory storage medium operatively connected to the processor, the non-transitory storage medium comprising computer-readable instructions; the processor, upon executing the instructions, being configured for: embedding unique identifiers into a plurality of streams, each one of the plurality of streams being associated with a respective one of the unique identifiers and with a respective one of a plurality of display devices; transmitting the plurality of streams to a plurality of display devices, each one of the plurality of streams being transmitted to a respective one of the plurality of display devices; receiving from a user device an indication of a given one of the unique identifiers; assigning a given one of the plurality of display devices that is associated with the given one of the unique identifiers to the user, thereby obtaining a pairing between the user and the given one of the plurality of display devices; and outputting the pairing.

According to still another broad aspect, there is provided a system for personalizing content delivery in an Over-The-Top broadcast system, the system comprising: a processor; a non-transitory storage medium operatively connected to the processor, the non-transitory storage medium comprising computer-readable instructions; the processor, upon executing the instructions, being configured for: embedding unique identifiers into a plurality of streams, each one of the plurality of streams being associated with a respective one of the unique identifiers and with a respective one of a plurality of display devices; transmitting the plurality of streams to a plurality of display devices, each one of the plurality of streams being transmitted to a respective one of the plurality of display devices; receiving from a user device an indication of a given one of the unique identifiers; assigning a given one of the plurality of display devices that is associated with the given one of the unique identifiers to the user, thereby obtaining a pairing between the user and the given one of the plurality of display devices; generating personalized content for the user; embedding the personalized content into a given one of the plurality of streams that is associated with the given one of the unique identifiers, thereby obtaining a personalized stream; and transmitting the personalized stream to the given one of the plurality of display devices.

In some embodiments, the processor is further configured for receiving a pairing request from the user device.

In some embodiments, the unique identifiers comprise one of barcodes, QR-codes, images, numbers, alphanumeric codes and sounds.

In some embodiments, the processor is configured for retrieving the personalized content associated with the user from a database.

In some embodiments, the processor is configured for receiving, from the user device, an indication of predetermined content to be embedded in the given one of the plurality of streams.

In some embodiments, the processor is configured for replacing at least a portion of a content of the given one of the plurality of streams with the personalized content.

In some embodiments, the at least a portion of the content is one of predetermined and arbitrary.

In some embodiments, the processor is configured for inserting the personalized content between at least two portions of a content of the given one of the plurality of streams.

In some embodiments, the processor is further configured for generating the unique identifiers.

In some embodiments, the processor is further configured for retrieving the unique identifiers from a database containing pre-generated unique identifiers.

According to still a further broad aspect, there is provided a system for personalizing content delivery in an Over-The-Top broadcast system, the system comprising: a processor; a non-transitory storage medium operatively connected to the processor, the non-transitory storage medium comprising computer-readable instructions; the processor, upon executing the instructions, being configured for: embedding unique identifiers into a plurality of streams, each one of the plurality of streams being associated at a given time with a respective one of the unique identifiers and with a respective one of a plurality of display devices; transmitting the plurality of streams, each one of the plurality of streams being transmitted to a respective one of the plurality of display devices; receiving from a user device an indication of a given one of the unique identifiers; assigning, to the user, a given one of the plurality of streams that corresponds to: the given one of the unique identifiers; and the given time at which the given one of the unique identifiers had been embedded into a respective one of the plurality of streams, thereby obtaining a pairing between the given one of the plurality of streams and the user; and outputting the pairing.

In some embodiments, the processor is further configured for generating personalized content for the user; embedding the personalized content into the given one of the plurality of streams, thereby obtaining a personalized stream; transmitting the personalized stream to a given one of the plurality of display devices that is associated with the given one of the unique identifiers.

In some embodiments, the processor is further configured for receiving a pairing request from the user device.

In some embodiments, the unique identifiers comprise one of barcodes, QR-codes, images, numbers, alphanumeric codes and sounds.

In some embodiments, the processor is configured for retrieving the personalized content associated with the user from a database.

In some embodiments, the processor is configured for receiving, from the user device, an indication of predetermined content to be embedded in the given one of the plurality of streams.

In some embodiments, the processor is configured for replacing at least a portion of a content of the given one of the plurality of streams with the personalized content.

In some embodiments, the at least a portion of the content is one of predetermined and arbitrary.

In some embodiments, the processor is configured for inserting the personalized content between at least two portions of a content of the given one of the plurality of streams.

In some embodiments, the processor is further configured for generating the unique identifiers.

In some embodiments, the processor is further configured for retrieving the unique identifiers from a database containing pre-generated unique identifiers.

Definitions In the context of the present specification, a “server” is a computer program that is running on appropriate hardware and can receive requests (e.g., from electronic devices) over a network (e.g., a communication network), and conducting those requests, or causing those requests to be carried out. The hardware may be one physical computer or one physical computer system, but neither is required to be the case with respect to the present technology. In the present context, the use of the expression a “server” is not intended to mean that every task (e.g., received instructions or requests) or any particular task will have been received, carried out, or caused to be carried out, by the same server (i.e., the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expressions “at least one server” and “a server”.

In the context of the present specification, “user device” is any apparatus or hardware that can run software appropriate to the relevant task at hand. Thus, some (non-limiting) examples of user devices include general purpose personal computers (desktops, laptops, netbooks, etc.), mobile computing devices, smartphones, and tablets. The use of the expression “a user device” does not preclude multiple devices being used in receiving/sending, carrying out or causing to be carried out any task or request, or the consequences of any task or request, or steps of any method described herein.

In the context of the present specification, the expression “computer readable storage medium” (also referred to as “storage medium”, “memory” and “storage”) is intended to include non-transitory media of any nature and kind whatsoever, including without limitation RAM, ROM, disks (CD-ROMs, DVDs, floppy disks, hard drivers, etc.), USB keys, solid state-drives, tape drives, etc. A plurality of components may be combined to form the computer information storage media, including two or more media components of a same type and/or two or more media components of diverse types.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the expression “information” includes information of any nature or kind whatsoever capable of being stored in a database. Thus, information includes, but is not limited to audiovisual works (images, movies, sound records, presentations etc.), data (location data, numerical data, user credentials, user preferences, etc.), text (opinions, comments, questions, messages, etc.), documents, spreadsheets, lists of words, etc.

In the context of the present specification, unless expressly provided otherwise, an “indication” is a signal of any nature carrying information required to convey an instruction, a response or a preference to another device.

In the context of the present specification, the expression “communication network” or “network” is intended to include a telecommunications network such as a computer network, the Internet, a telephone network, a Telex network, a TCP/IP data network (e.g., a WAN network, a LAN network, etc.), and the like. The term “network” includes a wired network or direct-wired connection, and wireless media such as acoustic, radio frequency (RF), infrared and other wireless media, as well as combinations of any of the above.

In the context of the present specification, sub-units of a stream may be termed as “portions,” “content blocks,” “packets,” “segments” or using other terminology common in the art. It will be understood that these terms may be used interchangeably for clarity unless expressly indicated otherwise. Accordingly, statements directed to a portion of a stream may be directed to a content block, to a packet, to a segment, or to a plurality of the same, and vice-versa, unless the context dictates otherwise.

In the context of the present specification, “an asset” defines content, such as a concert, a song, a documentary, a movie, a TV show or a segment thereof.

In the context of the present specification, a “channel” means broadcast content that can be viewed on a display device by a user.

In the context of the present specification, “companion app” and “application” mean software capable of being executed independently from the display device or the software playing the stream, and include software capable of being executed on a mobile device or other computing devices. It will be understood that the term may mean instructions causing a device to execute the steps associated with a companion app written in any suitable programming language (e.g. Java™, Javascript™, Python™, HTML, etc.).

In the context of the present specification, “offset” means a time delay added to a stream.

In the context of the present specification, “stream” means content being continuously provided to a single display device, for example but without limitation continuous video/audio. A stream may comprise other content and it will be understood that the insertion, substitution or other alteration of the content of a stream does not affect the content's nature as a “stream.”In the context of the present specification, the words “first,” “second,” “third,” etc. have been used as adjectives only for the purpose of allowing for distinction between the nouns that they modify from one another, and not for the purpose of describing any particular relationship between those nouns. Thus, for example, it should be understood that, the use of the terms “server” and “third server” is not intended to imply any particular order, type, chronology, hierarchy or ranking (for example) of/between the server, nor is their use (by itself) intended imply that any “second server” must necessarily exist in any given situation. Further, as discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 depicts an exemplary system implementing a pairing method according to the present disclosure.

FIG. 2 depicts an alternative configuration of a system implementing a pairing method according to the present disclosure.

FIG. 3 depicts a configuration of a system, comprising multiple display devices, implementing a pairing method according to the present disclosure.

FIG. 4 depicts an alternative configuration of a system comprising multiple display devices implementing a pairing method according to the present disclosure.

FIG. 5 depicts a schematic representation of an exemplary stream with and without a unique identifier.

FIG. 6 depicts an exemplary content personalization according to the present disclosure.

FIG. 7 depicts an exemplary system implementing a pairing method comprising variable unique identifiers according to the present disclosure.

FIG. 8 depicts an exemplary method of pairing a user to a stream according to the present disclosure.

FIG. 9 depicts an exemplary method of pairing a user to a stream accounting for time delays according to the present disclosure.

FIG. 10 depicts exemplary steps for assigning a stream to a display device associated with a user accounting for a time offset according to the present disclosure.

FIG. 11 depicts an exemplary method of pairing a user to a stream comprising unique identifiers embedded into streams at half the duration of an offset.

FIG. 12 depicts another exemplary method of pairing a user to a stream comprising unique identifiers embedded intermittently into a plurality of streams.

FIG. 13 depicts an exemplary method of personalizing content in a paired stream according to the present disclosure.

FIG. 14 depicts a schematic diagram of a computing device in accordance with one or more non-limiting implementations of the present technology.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor” or a “graphics processing unit,” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In one or more non-limiting embodiments of the present technology, the processor may be a general-purpose processor, such as a central processing unit (CPU) or a processor dedicated to a specific purpose, such as a graphics processing unit (GPU). Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

With these fundamentals in place, we will now consider some non-limiting examples to illustrate various implementations of aspects of the present technology.

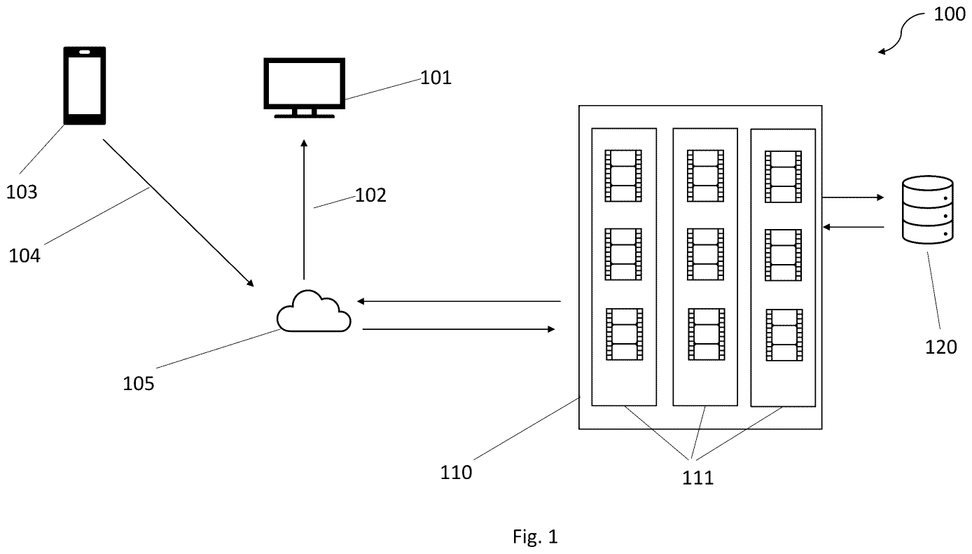

Referring to FIG. 1, there is shown an exemplary system 100 on which the methods disclosed herein may be implemented. It is to be expressly understood that the system 100 as shown is merely an illustrative implementation of the present technology. Thus, the description thereof that follows is intended to be only a description of illustrative examples of the present technology. This description is not intended to define the scope or set forth the bounds of the present technology. In some cases, what are believed to be helpful examples of modifications to the system 100 may also be set forth below. This is done merely as an aid to understanding, and, again, not to define the scope or set forth the bounds of the present technology. These modifications are not an exhaustive list, and, as a person skilled in the art would understand, other modifications are likely possible. Further, where this has not been done (i.e., where no examples of modifications have been set forth), it should not be interpreted that no modifications are possible and/or that what is described is the sole manner of implementing that element of the present technology. As a person skilled in the art would understand, this is likely not the case. In addition, it is to be understood that the system 100 may provide in certain instances simple implementations of the present technology, and that where such is the case they have been presented in this manner as an aid to understanding. As persons skilled in the art would understand, various implementations of the present technology may be of a greater complexity.

The system 100 comprises a display device 101. The display device 101 may be a television, a computer monitor, a smart TV, a projector, including a holographic projector, a smartphone display, a digital media player or streaming device connected to a display, or another display device of similar functionality. The display device 101 receives a broadcast signal 102. The broadcast signal 102 may be received by the display device 101 through numerous acceptable means, for example through Wi-Fi™ Ethernet™, an antenna cable, an HDMI cable, Bluetooth™, mobile data and infrared communication.

The exemplary system 100 may comprise a user device 103, which may be a smartphone, a tablet, a laptop or the like. The user device 103 may be configured to send a signal 104. The signal 104 may be a pairing request, an indication, an instruction, a response to interactive content, or another acceptable signal.

Display device 101 and user device 103 may be connected to a network 105, for example to a home Wi-Fi network.

The exemplary system 100 comprises at least one server 110. In the exemplary system 100, the server 110 may be configured, inter alia, to provide one or more streams 111 over a network to one or more devices, including display device 101. It will be appreciated that the server 110 can be implemented as a conventional computer server. In a non-limiting example of one or more embodiments of the present technology, the server 110 is implemented as a server running an operating system (OS). Needless to say that the server 110 may be implemented in any suitable hardware and/or software and/or firmware or a combination thereof. In a non-limiting embodiment of present technology, the server 110 is a single server. In one or more alternative non-limiting embodiments of the present technology, the functionality of the server 110 may be distributed and may be implemented via multiple servers (not shown). It will also be understood that the streams may be live streams, for example HLS or pre-programmed streams.

The exemplary system 100 further comprises a database 120. The database 120 may be configured to store stream content, personalized content, user profiles, user credentials, device characteristics, such as technical specifications and user preferences for display device 101, and/or other information useful for the functioning of exemplary system 100.

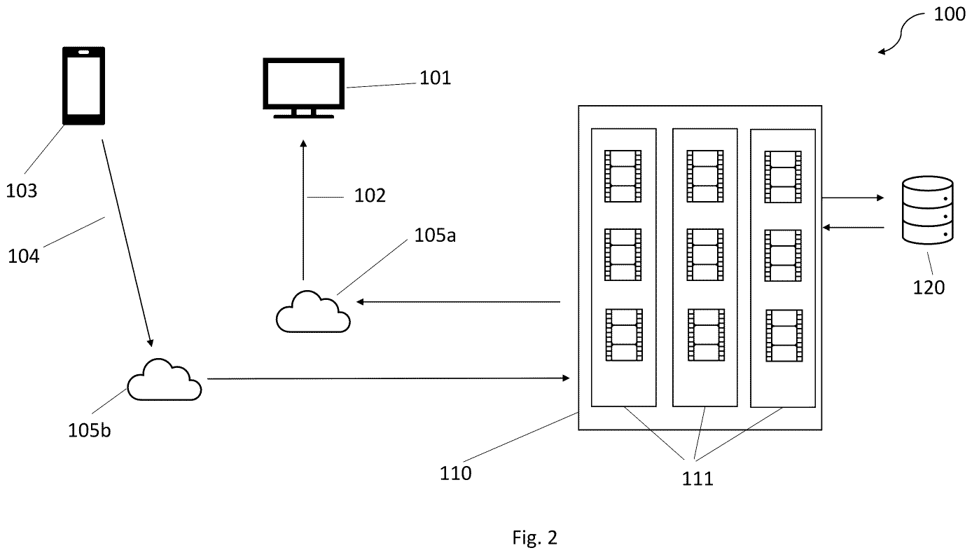

Referring to FIG. 2, an alternative configuration of the exemplary system 100 is presented, wherein user device 103 and display device 101 are connected to different networks 105a and 105b. As can be seen from FIG. 2, both networks 105a and 105b may communicate with the server 110. For example, network 105a may be a home Wi-Fi™ network, and network 105b may be a mobile network. It will be understood that the exemplary system 100 is agnostic to the nature of networks 105, 105a and 105b.

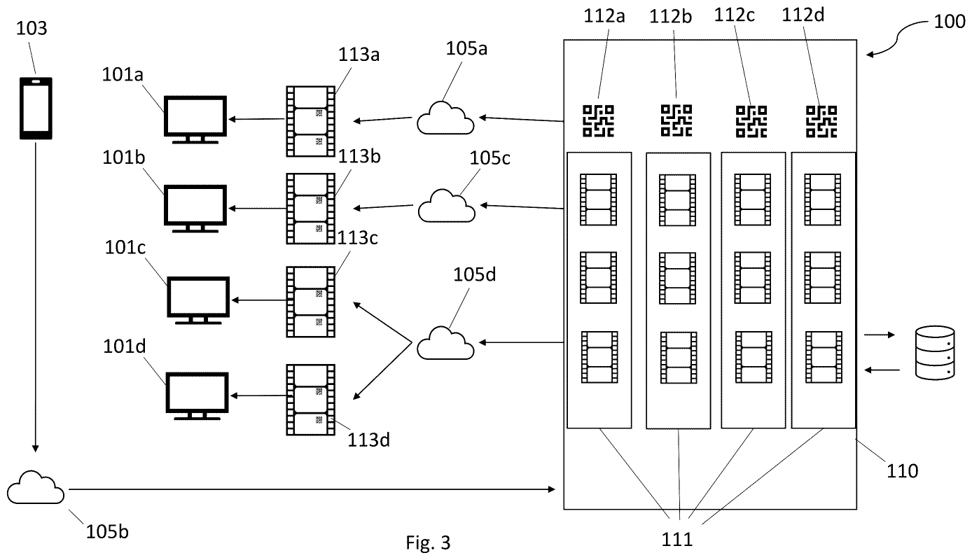

Referring now to FIG. 3, an example of the operation of the exemplary system 100 is presented. A server 110 is transmitting a plurality of streams 111 to a plurality of display devices 101a, 101b, 101c and 101d, which streams may be associated with different devices within the same household, different households or combinations thereof. For example, the plurality of display devices 101a, 101b, 101c and 101d may be connected to a plurality of networks 105a, 105c and 105d, for example a plurality of household Wi-Fi networks. It will be understood that the streams 111, at this point, are associated by the server 110 to respective display devices 101, however the server 110 has not obtained a pairing of a given stream 111 to a user. Customization or personalization of the content of a stream 111 is therefore difficult.

A user device 103 is connected to a network 105b such as a mobile network. The user device 103 is configured to send a signal 104 comprising a pairing request to the server 110. Different ways can be envisioned by a skilled person to send a pairing request. For example, the pairing request may be initiated from a mobile browser page or an application on user device 103. The user device 103 may itself be associated with a user, for example by correlating a user profile with the user device's Media Access Control (MAC) address. Alternatively, the user device 103 may comprise means to associate the user device 103 with a user temporarily, such as through an application or browser log-in. It will be understood that an application configured to send a pairing request or to perform other steps associated with the pairing methods disclosed herein may be integrated into the display device or into devices connected to the display device, for example a Set Top Box.

The server 110 receives the pairing request from the user device 103. The pairing request may indicate a request by a user for server 110 to provide personalized content as part of one of the streams 111. The server 110 is configured to embed a respective unique identifiers 112a, 112b, 112c, 112d into the streams 111, each unique identifier 112a, 112b, 112c, 112d being associated with a respective display device 101a, 101b, 101c, 101d, to obtain modified streams 113a, 113b, 113c and 113d. It should be understood that the modified stream 113a corresponds to the stream 111 in which the unique identifier 112a has been embedded, the modified stream 113b corresponds to the stream 111 in which the unique identifier 112b has been embedded, etc. Since each unique identifier 112a, 112b, 112c, 112d is associated with a respective display device 101a, 101b, 101c, 101d, it should be understood that the same association applies to the modified streams 113a, 113b, 113c and 113d, i.e., the modified stream 113a is associated with the display device 101a, the modified stream 113b is associated with the display device 101b, etc.

While in FIG. 3, the unique identifiers 112a, 112b, 112c and 112d are shown as QR codes, it will be readily apparent that other means for identifying a particular stream 111 are acceptable. For example, the unique identifiers 112a, 112b, 112c and 112d may be barcodes, images, numbers, phrases, alphanumeric codes, sounds, or other identifiers suitable for embedding in a stream 111.

The modified streams 113a, 113b, 113c and 113d, comprising the content of the stream 111 and a respective unique identifiers 112a, 112b, 112c, 112d, are transmitted to the plurality of display devices 101 via a respective network 105a, 105c, 105d associated with the display device 101a, 101b, 101c, 101d. For example, the modified stream 113a which corresponds to the stream 111 in which the unique identifier 112a is embedded is transmitted to the display device 101a via the network 105a. In another example, the modified stream 113c, which corresponds to the stream 111 in which the unique identifier 112c is embedded, is transmitted to the display device 101c via the network 105d while the modified stream 113d, which corresponds to the stream 111 in which the unique identifier 112c is embedded, is transmitted to the display device 101d via the network 105d also Display devices (such as display devices 101c and 101d) which are connected to a same network such as network 105d, for instance two televisions connected to the same home Wi-Fi network, each receive a respective modified stream 113, such as modified streams 113c and 113d, respectively, comprising a respective unique identifier such as unique identifiers 112c and 112d, respectively.

It should be understood that, in one or more implementations, at each point in time, each unique identifier 112a, 112b, 112c, 112d is associated with a single stream 111.

The user device 103 is configured to send a further signal 104 to the server 110. The further signal is indicative of the unique identifiers 112a, 112b, 112c, 112d received by the user. For example, if the user is in front of the display device 101c, the further signal transmitted by the user device 103 to the server 110 is indicative of the unique identifier 112c. For example, using the user device 113, the user may scan the unique identifier 112c while it is shown on display device 101c. If the unique identifier 112c embedded into the modified stream 113c is an alphanumeric code, the user may read the alphanumeric code displayed on the display device 101c and input the alphanumeric code into the user device 103.

The server 110 receives the indication of the unique identifier 112a, 112b, 112c, 112d from the user device 103 and determines which given stream 113a, 113b, 113c, 113d and therefore which display device 101a, 101b, 101c, 101d are associated with the user based on the received indication of the unique identifier 112a, 112b, 112c, 112d. Referring back to the previous example, the server 110 receives the unique identifier 112c from the user device 103 and determines that the display device 101c is associated with the user or the user device 103. The server 110 then pairs the user or the user device 103 to the determined display device 101a, 101b, 101c, 101d. Referring back to the previous example, the server 110 pairs the user to the display device 101c. It should be understood that pairing the user or user device 103 to a given display device 101a, 101b, 101c, 101d is equivalent to pairing the user or user device 103 to a given modified stream 113a, 113b, 113c, 113d to be sent to the given display device 101a, 101b, 101c, 101d since each modified stream 113a, 113b, 113c, 113d is uniquely associated with a respective display device 101a, 101b, 101c, 101d.

In one or more implementations, the pairing between the user and the given display device 101a, 101b, 101c, 101d (or the pairing between the user and the given modified stream 113a, 113b, 113c, 113d to be sent to the given display device 101a, 101b, 101c, 101d) is outputted, i.e. the identification of the user and the identification the given display device 101a, 101b, 101c, 101d (or the given modified stream 113a, 113b, 113c, 113d) are outputted. For example, the pairing may be stored in memory.

The stream 111 being transmitted to the determined display device 101a, 101b, 101c, 101d is now paired to the user or user device 103.

In some embodiments, the insertion of the unique identifiers 112a, 112b, 112c, 112d in the streams 111 is stopped only once the user has been paired with one of the display devices 101a, 101b, 101c and 101d. In other embodiments, the unique identifiers 112a, 112b, 112c, 112d are inserted into the streams 111 for a given period of time only, after which the unique identifiers 112a, 112b, 112c, 112d no longer inserted into the streams 111. In some embodiments, the unique identifiers 112a, 112b, 112c, 112d may be inserted continuously or persistently into the streams 111, for example if a stream, a channel or a server are configured to be in constant pairing mode.

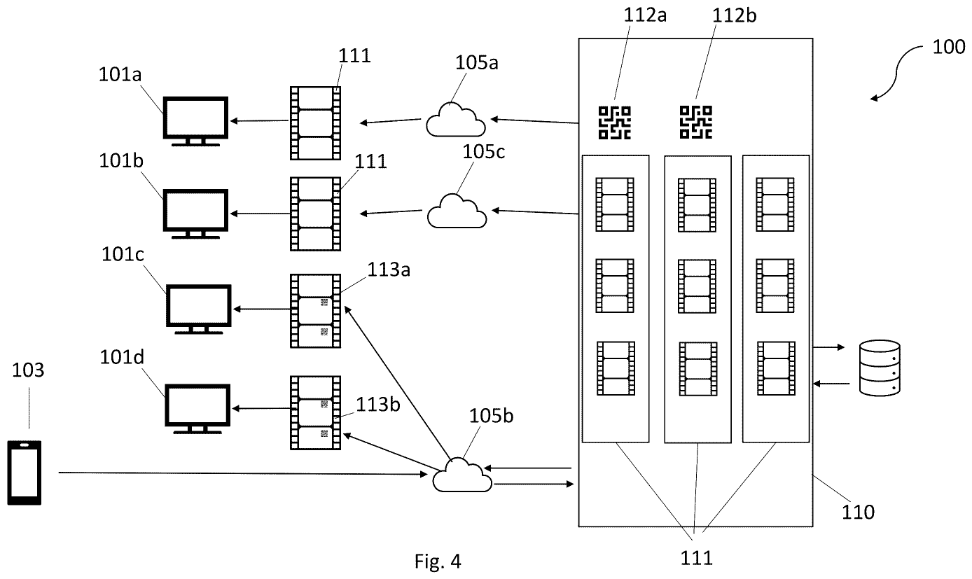

Referring now to FIG. 4, an alternative implementation of the method described above addresses the situation when one or more display devices 101a, 101b, 101c and 101d and the user device 103 are connected to the same network. In the illustrated embodiment, the display devices 101c and 101c are connected to the network 105b to which the user device 103 is also connected.

The server 110 receives a pairing request from the same network 105a, 105b, 105c to which the one or more display devices 101a, 101b, 101c and 101d are connected. The server 110 then embeds unique identifiers 112a, 112b, only into the streams 111 that are destined to the network 105a, 105b, 105c from which the pairing request was received, i.e. only to the display devices 101a, 101b, 101c and 101d which are connected to the same network 105a, 105b, 105c. In the illustrated embodiment, the server 110 receives the pairing request from the server 105b to which the display devices 101c and 101d are connected. In this case, the server 110 generates only two unique identifiers 112a and 112b which are each embedded into a stream 111 to generate the modified stream 113a and 113b which are associated with the display devices 101c and 101d, respectively. The modified stream 113a and 113b are transmitted to the display devices 101c and 101d, respectively, via the network 105b from which the pairing request was received while the unmodified stream 111 continues to be transmitted to the display devices 101a and 101b via the networks 105a and 105c, respectively.

Accordingly, a smaller number of streams 111 is modified with a unique identifier. This reduces the computational and processing power required to perform the method disclosed herein and improves the experience of users who did not request a pairing by maintaining continuity in the streams 111 transmitted to those users. Accordingly, the unmodified stream 111 continues to be transmitted to the display devices 101a and 101b connected to networks 105a and 105c which are not associated with user device 103, whereas the display devices 101c and 101d connected to the network 105b associated with the user device 103 receive the modified streams 113a and 113b, respectively.

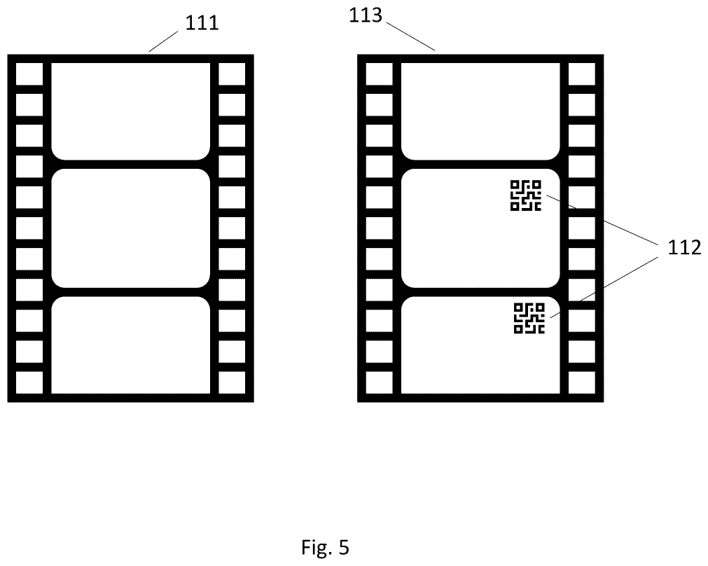

Referring now to FIG. 5, a detailed view of at least a portion of the content of streams 111 and 113 with and without unique identifiers 112, respectively, is shown. It will be understood that while streams 111 and 113 are depicted as film reels, the present disclosure is applicable to all stream types and technologies permitting the embedding of a unique identifier into the stream.

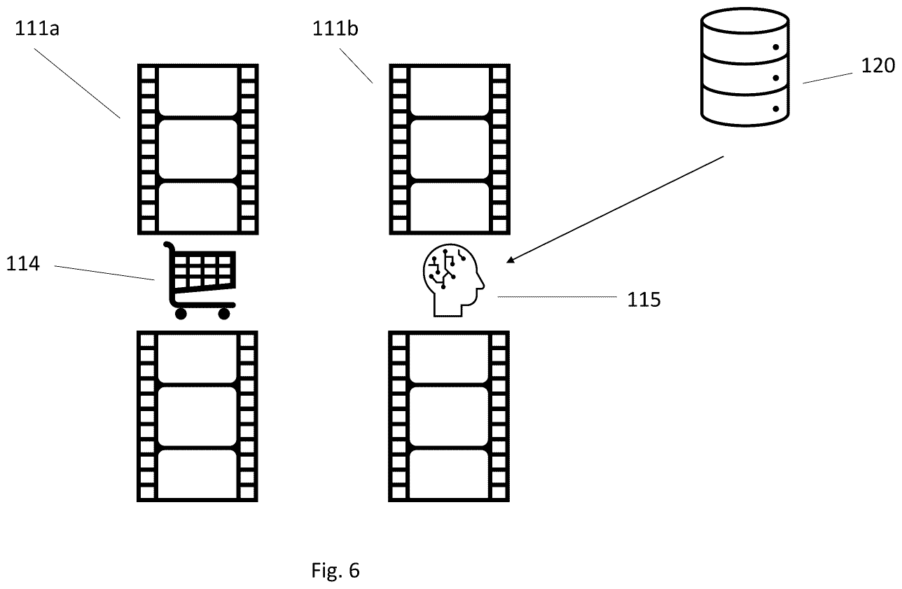

Referring now to FIG. 6, a representation of an exemplary personalization of a stream is presented. Prior to pairing, streams 111a and 111b (of which the content is identical) have not been personalized. Accordingly, for example, the streams 111a and 111b would present users a predetermined generic advertisement block or packet 114. Following pairing (not shown in FIG. 6), stream 111b may be personalized. For example, a user to whom stream 111b is paired should receive a content block different from generic advertisement block 114. Personalization parameters, indications, content and profiles may be stored in any convenient memory. For example, a user profile comprising personalization parameters may be stored in the database 120. In other examples, the database 120 may comprise one or more personalized content blocks, and an indication corresponding to one or more personalized content blocks may be received from another device, for example another server (not shown) or a user device 103. In the example depicted in FIG. 6, not intending to be limited by the specific embodiment described, upon the pairing of stream 111b to a user, a server, such as server 110, retrieves a personalized content block, in this case a survey block 115 from the memory or database 120. The retrieving may be governed according to various personalization methods, including retrieving a user profile or stored instructions regarding personalization of a stream. For example, the server 110 or the database 120 may comprise a user profile comprising an indication of a user preference, wherein the indication corresponds to replacing generic advertisements, such as generic advertisement block 114, with personalized content blocks, such as a quiz or survey block 115. The server, for example server 110, retrieves a quiz or survey block 115 from database 120 and replaces generic advertisement block 114 with the quiz or survey block 115 in stream 111b paired to the user. The user's experience is thus improved.

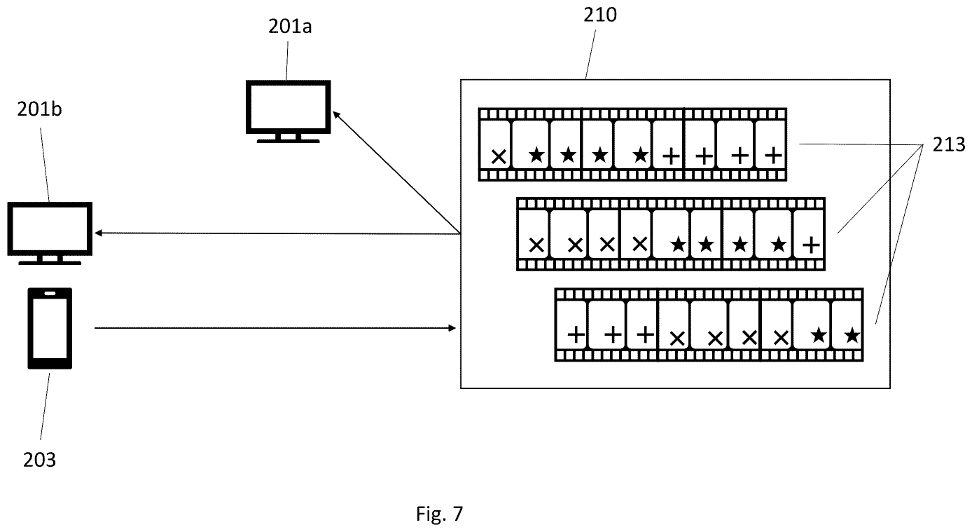

Referring now to FIG. 7, the operation of an exemplary system applying a method according to the present disclosure is presented. A server 210 receives a pairing request from user device 203. The server 210 transmits modified streams 213 to display devices 201a and 201b. It will be understood that there may be a plurality of display devices, for example 5, 10, 100, or more display devices receiving modified streams 213. The streams 213 each comprise a unique identifier, shown in FIG. 7 as different shapes for greater clarity. The embedding of unique identifiers into the streams (not shown) to yield modified streams 113 follows a time offset pattern, whereby each unique identifier 112 is associated with only one stream at any given time.

Methods of pairing users and streams will now be described in greater detail.

It will be understood that the exemplary system 100 may be configured to pair a user to a stream based on IP address alone. In such an example, the system determines the IP address of the user device 103 and matches it to the IP address of the display device 101, outputting a paired stream. In the case of the presence of the X-Forwarded-For header, the left-most IP address is the user device's 103 original IP address and is the one that is used for the pairing. Failing to match an IP address would prompt the user to verify they are on the same network and is not using a VPN or a mobile network or other network means that would cause an IP mismatch between the user device 103 and the display device 101.

In one or more implementations, the methods disclosed herein improve the pairing of a user to a stream in a situation where multiple devices use the same IP address, hence pairing on IP address alone would not determine which display device 101 the user wishes to watch the paired stream on. Conventional systems and methods may, in such a situation, display an error to the user explaining that pairing could not be done because the paired stream may be transmitted to a plurality of display devices 101, or a list of display devices 101 could be shown to the user to choose from. This approach may be prone to error.

In one or more implementations, unique identifier pairing improves the user experience and the reliability of pairing methods.

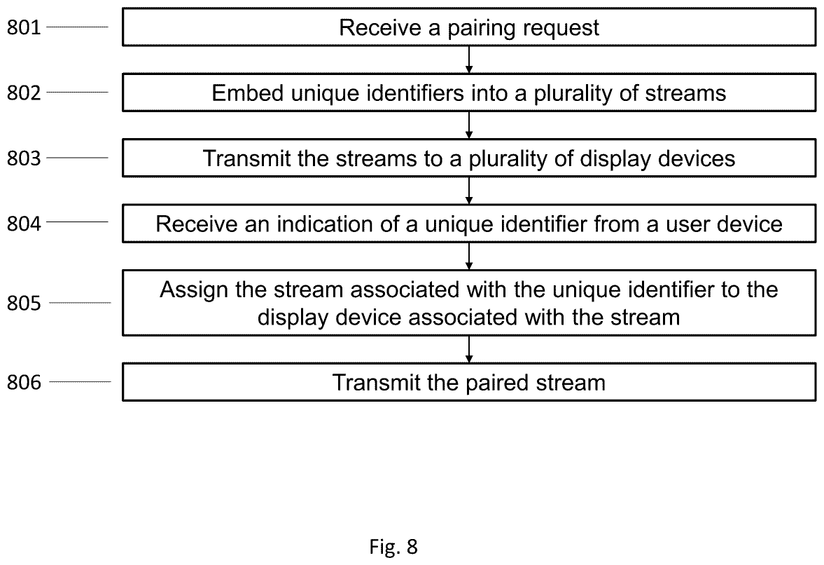

Referring now to FIG. 8, a method 800 of pairing a user to a stream is presented. A server receives a pairing request from a user device, which may be a mobile phone, or any other device configured to transmit an instruction to a server. In the case of a smart display device, where the display device may communicate with a server rather than simply receive signals, the user device may be a remote control.

The user may initiate the pairing request by any adequate means. The user device may comprise an application configured to send pairing requests to a server. The application may be unique to the user device, for example the application includes the user device's MAC address associated to the user in the pairing request. The application may be configured to be unique to each user at any given time, allowing different users on the same user device, for example through a log-in process. Alternatively, the pairing request may be initiated by visiting a web page or a mobile browser page.

The application could be a pure companion app, for example an application comprising only a pairing functionality. The application may be an application capable of playing channels, streams or assets. The application could also be an existing application comprising, additionally, a pairing feature. The application may be an existing live sports provider application configured, for example through an update, to cause the user device to perform one or more of the pairing steps disclosed herein.

The pairing request may comprise one or more indicators corresponding to parameters useful in performing a pairing including a username or another user identifier, an IP address, a MAC address of the user device and/or location data.

Upon receiving the pairing request at step 801, the server embeds a plurality of unique identifiers into a plurality of streams at step 802 and transmits the plurality of modified streams to a plurality of display devices at step 803. It should be understood that each modified stream is associated with a respective unique identifier and a respective display device.

The unique identifiers may be generated by the server, for example by using a processor comprised in the server. The unique identifiers may be generated in response to the pairing request. The unique identifiers may be generated at a different time, for example by being previously generated by any adequate means and stored in a memory for retrieval in response to a pairing request. Creating a “bank” of pre-generated unique identifiers to be stored in a memory reduces the hardware and network resources required to implement the methods disclosed herein.

In an example, a server may retrieve a plurality of unique identifiers from a memory in response to a first pairing request, the plurality being less than the total number of unique identifiers stored in the memory. The server may then retrieve additional unique identifiers in response to a second pairing request from a different user device, thereby reducing the possibility of conflicting pairings.

The unique identifiers may be QR codes or other distinctive prompts that may allow the methods disclosed herein to be implemented, such as sounds, numbers, barcodes, phrases or other prompts. Referring back to the example wherein the display device is a smart display device capable of communicating with the server, the server may embed numbers into the stream as unique identifiers, prompting the user to press a corresponding button on their remote.

The streams comprising the embedded unique identifiers are transmitted to a plurality of display devices at 803. The plurality of display devices may be located in a plurality of households, and some display devices may be located in the same household or on the same local network thereby sharing a same IP address. A server may adapt the embedding step 802 and the transmission step 803 to characteristics of the pairing request. For example, when the pairing request comprises an IP address and the IP address in the pairing request matches the IP address of one or more display devices currently streaming from the server, the server may embed unique identifiers only into those streams that are transmitted to said IP address.

When a unique identifier is a QR code, a user device such as a smartphone can be used to scan the unique identifier appearing on the display device. The QR code may contain the instructions required to cause the user device to send an indication to a server corresponding to the unique identifier. The user may, accordingly, not need to perform other actions except to cause the user device to scan the QR code. Alternatively, the QR code may cause the user device to generate an indication corresponding to the QR code, however the user may have to instruct the device to send the indication. The indication may be sent by the user device using any acceptable transmission means, such as Wi-Fi or mobile data.

A server receives the indication of the unique identifier at step 804. The indication corresponds to a unique identifier. For example, the indication may correspond to the unique identifier QR code being scanned by the camera of a user device, such as a smartphone, while being displayed on the display device. Alternatively, the unique identifier may be a number, and an application present on the user device may prompt the user to enter the number.

Upon receiving the indication at step 804, the server may now assign a particular stream from the plurality of streams to the display device to which the modified stream was being transmitted at step 805. The stream is now paired to the user watching the display device. Personalization of the stream tailored to the specific user is now possible without affecting the content of other streams broadcasted to other users, even within the same household or on the same Wi-Fi network.

The server transmits the paired stream to the display device at step 806.

Steps 801 to 806 may be performed by the same server configured accordingly. However, the methods disclosed herein may be implemented across a plurality of servers, for example comprising content provision servers, relay servers, database servers and other servers.

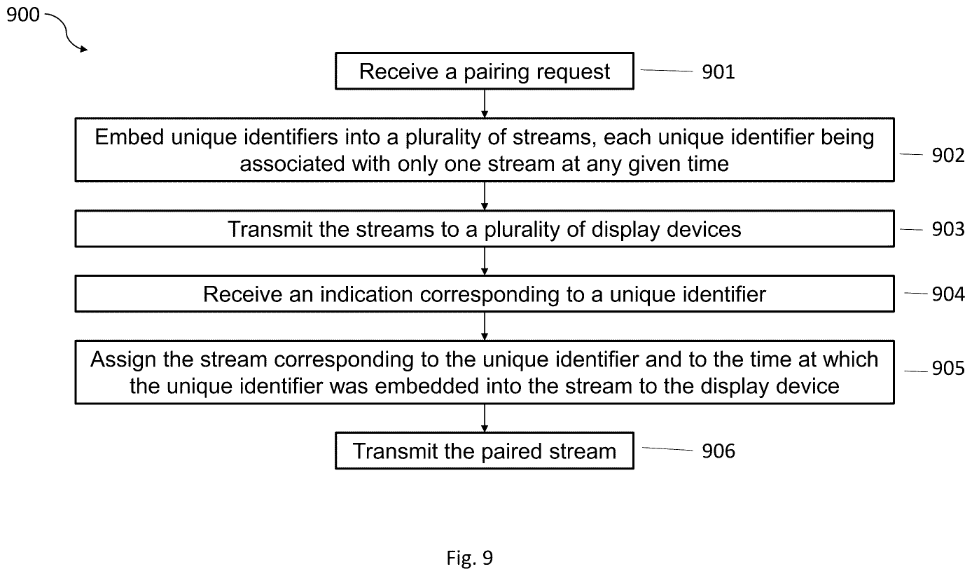

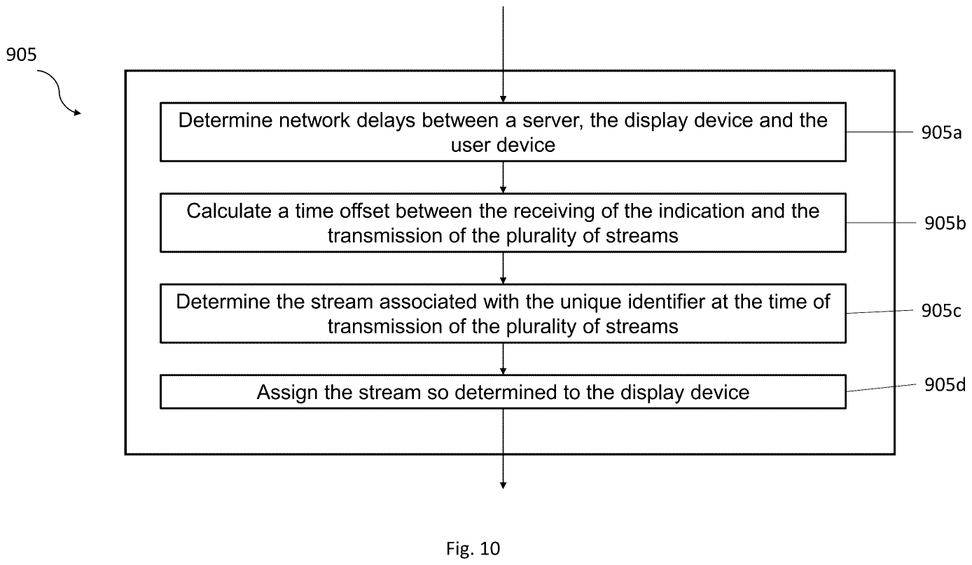

Referring now to FIGS. 9 and 10, a method 900 of pairing a display device to a user is presented. In method 900, the first step 901 comprises receiving a pairing request similarly to the pairing request in step 801 of method 800. The unique identifier may be embedded into the asset's media file for channels built with stitched assets.

At step 902, the server embeds a plurality of unique identifiers each into a respective one of a plurality of streams. The embedding performed at step 902 comprises varying the unique identifier embedded into any one given stream according to a predetermined time offset. For example, each unique identifier may be embedded into a given stream for 10 seconds, 15 seconds, 20 seconds, 30 seconds, or another predetermined time. Accordingly, the unique identifier in each stream transmitted to a display device will vary. In method 900, each unique identifier is associated with only one stream at any given time.

The server transmits the streams each comprising a respective unique identifier to a display device at 903. If the pairing request is associated with an IP address that matches the IP address to which one or more streams are being transmitted at the time of the pairing request, the server may embed the unique identifiers only in those streams being transmitted to the IP address matching the pairing request IP address.

At step 904, the server receives an indication corresponding to a unique identifier. The receiving of the indication is indicative of a unique identifier being received by a user or at a user device. For example, an indication may correspond to a unique QR code being displayed and scanned, or a number or another prompt being seen or heard by a user and input on a user device.

At step 905, the server determines the effects of network and transmission delays associated with the stream, the display device and the user device, and assigns a stream to the display device according to both the indication and estimated transmission, buffering and decoding delays. For example, the server may estimate network delays when a display device first starts streaming, for example by pinging a destination IP address or the display device itself, by querying destination hardware regarding network transmission speeds, or using other acceptable methods. The server may store such estimates and such information in memory, and retrieve them in response to receiving an indication corresponding to a unique identifier. The server may also estimate network delays in real time during the execution of method 900. Accordingly, the server may estimate when each unique identifier would be displayed on a display device. The server may store information regarding the time at which each unique identifier is inserted in its respective stream, for example in memory. Accordingly, the server may compare the value of the unique identifier corresponding to the indication with estimated values of the unique identifiers that display devices are expected to be playing at the time of receiving the indication.

During operation, the server or servers according to the present disclosure may broadcast streams with a time offset, i.e. streams may be provided by the server to display devices having a predetermined time offset, for example 5 s, 10 s, 12 s, 24 s, 30 s, etc. the server configuration may comprise a plurality of offsets and any given number of such offsets may be in use at one time. When a server begins streaming to a display device, the server may assign a currently unused offset to the display device. The server may be configured to have predetermined offsets of a duration equal to the duration of a predetermined duration of a unique identifier. The offsets may have a greater duration, for example twice as long as the predetermined duration of a unique identifier. It will be apparent to skilled persons that other offset durations are possible. It will be understood that this initial step is user-agnostic and does not pair a stream to a user.

It will also be understood that in the context of a linear broadcast, for example a live event, the streams may not comprise a time offset, however the unique identifiers may still be generated and/or embedded in an offset manner, thereby providing a differentiation between streams of a same linear broadcast.

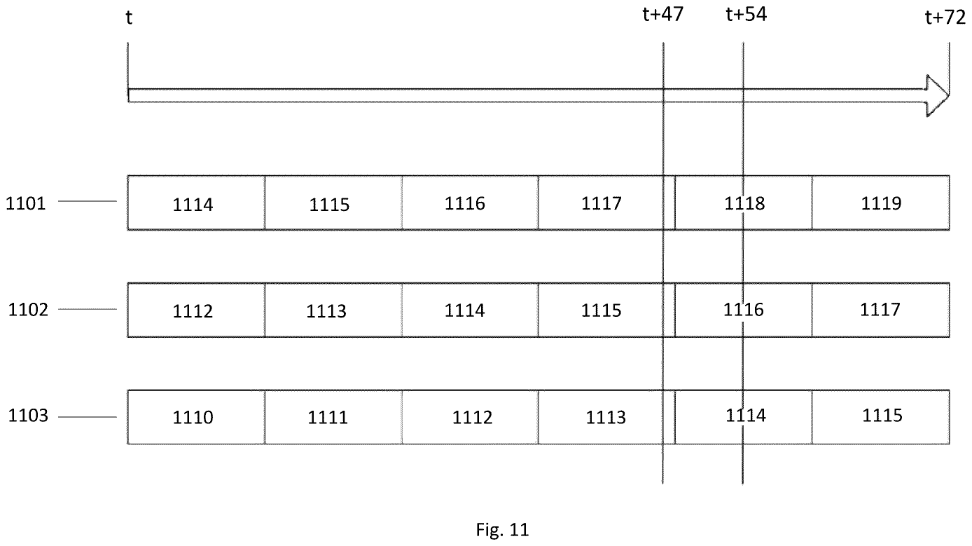

Referring now to FIG. 11, an exemplary implementation of the methods described herein is presented. Unique identifiers numbered 1110-1119 have a duration of 12 s and offsets have a duration of 24 s. Accordingly, two unique identifiers would be embedded within a stream in the duration of one offset. For example, taking a nominal time point as “t”, a stream transmitted by the server is at time ‘t+54 s’ and the server estimates playback position (i.e. what is currently seen/heard by the user) at time ‘t+47 s’, which denotes that there is an estimated 7s delay between streaming time and playback time. If the pairing server receives an indication corresponding to value of 1115, it should find that this matches to ‘stream 1102’ because it estimates the corresponding display device is currently playing unique identifier 1115. If the estimated position were a bit off and the unique identifier corresponding to the indication was 1116, the server would still determine that the indication matched stream 1102, as having the indication closest to the estimated position. It will be understood that the method depicted in FIG. 11 allows a degree of flexibility and for a margin of error in the estimation of playback time. It will also be understood that the unique identifiers need not be in any particular order so long as a record of the time at which the unique identifier was embedded in the stream is kept, and that unique identifiers may be reused over time.

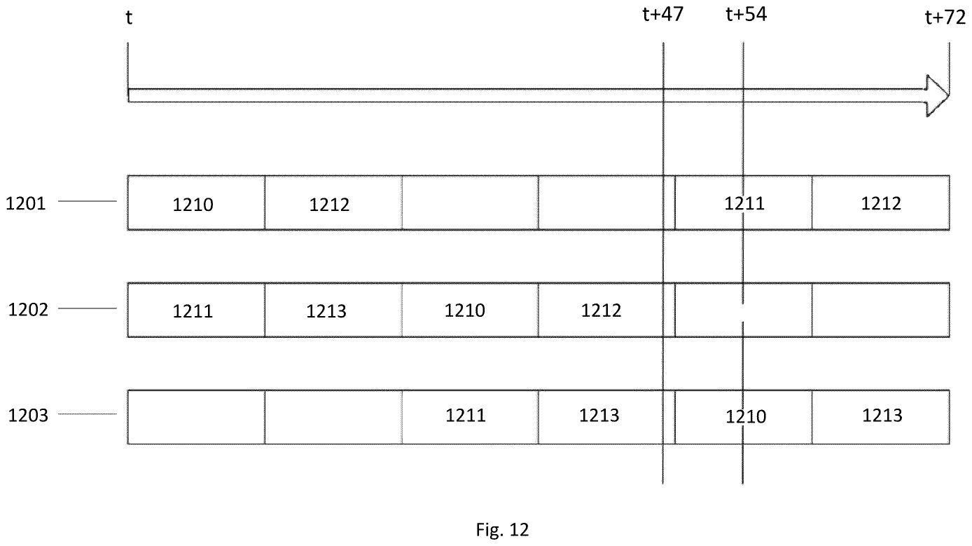

Referring now to FIG. 12, an alternative method according to the present disclosure is presented. A unique identifier may be embedded into only one stream at a time, alternating between streams. Other streams would not comprise a unique identifier while another stream is being transmitted with an embedded unique identifier. Different unique identifiers may be generated and/or embedded into different streams, allowing for scaling up of the method. In FIG. 12, streams 1201, 1202 and 1203 comprise embedded unique identifiers 1210-1214. Unique identifiers 1210-1214 have a duration of 12 s and are embedded into streams 1201-1203 every 24 s. Two unique identifiers are transmitted in parallel at a given time. Unique identifiers may be reused, although they do not have to be. The server, upon receiving an indication corresponding to unique identifier 1212 will match the indication to stream 1202. Just as with the example presented in FIG. 11 and described above, the estimated position can be slightly off, it would also be possible for the server to receive an indication corresponding to unique identifier 1210, which in this case the server should match to ‘stream 1203’. Alternating between streams allows pairing on all or a portion of them while maintaining recognition by the server of the indication corresponding to the stream and to the embedding time, while reducing the total quantity of unique identifiers to be generated or embedded. As can be seen in the exemplary method of FIG. 12, any given unique identifier is not used at adjacent time points on streams 1201, 1202 or 1203. It will also be apparent that a smaller number of unique identifiers must be generated and/or stored.

The methods and technologies described above may be combined. For instance, the available quantity of unique identifiers, may be adapted to pair one of a larger plurality of streams by embedding the unique identifiers intermittently as in described for FIG. 12. Accordingly, an exemplary method comprising 30-second offsets up to two minutes of pairing may generally require 5 unique identifiers. However, if a larger number of streams is playing at the time the pairing request is received, for example 10 streams, 5 unique identifiers would not suffice for unambiguous association of an indication with a stream. Embedding the identifiers intermittently and alternating the identifiers between streams may allow for pairing a larger number of streams without requiring additional unique identifiers.

Where a server may not be configured or capable of implementing a pairing method as described above, a reusable pool of assets may be pre-encoded with unique identifiers and those assets could be interleaved between other assets being provided to display devices, in a manner similar to advertisements. Where the streams are dynamic, these pre-encoded assets may be provided as pre-rolls. Each of a plurality of streams may have a unique identifier inserted at any one time, allowing this interstitial content method to be used alone or in combination with any of the methods disclosed above.

The methods and systems disclosed above may be configured to operate in conjunction with existing pairing, identification and stream allocation methods. For example, a user may be logged in with a Samsung™ account or a Google™ account on a TV or a TV-connected device, for example a smart TV, an Apple™ TV, an X-Box™. The TV or TV-connected device may then pass on a login ID to the server implementing the above methods. The user may then use the same credentials used to log into the TV or the TV-connected device to log in with the same account on the user device, for example on the companion app. A server would recognize the matching login credentials and present a list of device IDs to the user to choose from for the pairing.

A generic identifier could be embedded into the streams in order to bring the user to the companion app in the first place. This may prompt the user device to send a pairing request. The identifier could be dynamically chosen based on the account provider used by the display device, so that the companion app could suggest the user to directly login with the proper provider (e.g., Google, Samsung, Apple ID). In case the display device is not logged in with a supported provider account, or in case the account-based pairing method does not succeed, the system or server may switch to the generic identifier suggesting the user to log in to the companion app, or switch to the device-agnostic pairing methods described above.

The one or more servers could determine dynamically which pairing method(s) to use according to predetermined conditions. For example, a server may be configured to implement by default a method wherein a unique identifier is always embedded into the plurality of streams, for example as depicted in FIG. 11. The server may be configured to determine the number of streams currently playing and, if the number of streams exceeds a threshold for the currently available quantity of unique identifiers, the server may switch to an intermittent embedding method, for example as shown in FIG. 12. Depending on the number of streams currently playing, the server may be configured to retrieve additional unique identifiers from a memory or to generate additional unique identifiers, for example when a large plurality of display devices is receiving a large plurality of streams, such as during major sports events or highly anticipated content releases.

The server may assign an identifier to the display device, for example a unique device ID. The display device may pass an identifier to the server, for example a parameter, a header or a cookie. The server may be further configured to generate a pairing identifier, the pairing identifier being unique to each pairing. Upon obtaining a pairing, the server may be configured to make the pairing persistent, for example by providing the companion app with the pairing identifier. The server may be configured to store the association between a pairing ID and a display device in a memory. In some embodiments, the server may be configured to retrieve the pairing ID or other data identifying the association from the user device, for example from the companion app.

The server may be configured to make the pairing persistent across multiple channels. For example, the server may monitor and/or store data associated with the channel currently being played by the display device. Upon a user changing the channel, the server may retrieve a pairing ID associated with the user and the display device, for example from a memory or from the user device, and assign a stream of the new channel to the user, persisting the pairing.

The user device may be configured to prompt the user to select which channel the user is currently watching. In a multi-channel scenario, this method allows the server to minimise the number of unique identifiers to embed across multiple channels since a unique identifier may be embedded only into the streams that correspond to the selected channel. In other embodiments, the unique identifiers may comprise information respecting the channel into which they are embedded. For example, a unique identifier may be specific both to a channel and to a stream within that channel.

The user device and/or the server may be configured to allow multiple users to pair with the same display device. Accordingly, the server and/or the user device may store data associated with the pairings, for example a pairing ID. Upon a new user pairing to a stream on the display device, the server may cause one or more user devices to display a notification that a new pairing has been made on the display device.

The server and/or the user device may be configured to allow a user to pair to several display devices. The user device may accordingly store data associated with each pairing and prompting a user to select the pairing they wish to use. The user device may be configured to present the user with data regarding the availability or online status of display devices for which a pairing ID is stored by the server or by the user device.

A channel comprising a plurality of streams may always be in pairing mode, for example through the server being configured to continuously embed unique identifiers into the streams. The channel may enter into pairing mode upon the server detecting a user device on the same IP address as a display device currently receiving a stream of the channel.

Methods of personalizing content in an Over-the-Top broadcast will now be presented. Customization of Over-The-Top channels is possible according to several technologies. When the underlying technology is built on top of HTTP or protocols that require the display device or a software configured to display the stream on the display device to initiate requests to receive the stream, each corresponding response may be different from one display device or software to the other. In such protocols, the streams may be broken down into small chunks, such as packets or segments. For example, in some technologies such as HLS, a media playlist is returned to the display device or to the software comprising a number of segments. As time passes, the display device or software requests the same playlist from the server, corresponding to the same stream. The server provides an updated playlist with newer segments added and older segments removed.

It will be understood that the methods disclosed herein may be used with other technologies not comprising a display device or software requesting content from a server. For example, a server may be configured to provide a stream directly to a display device, thereby operating the substitution of older segments with new ones at the server end.

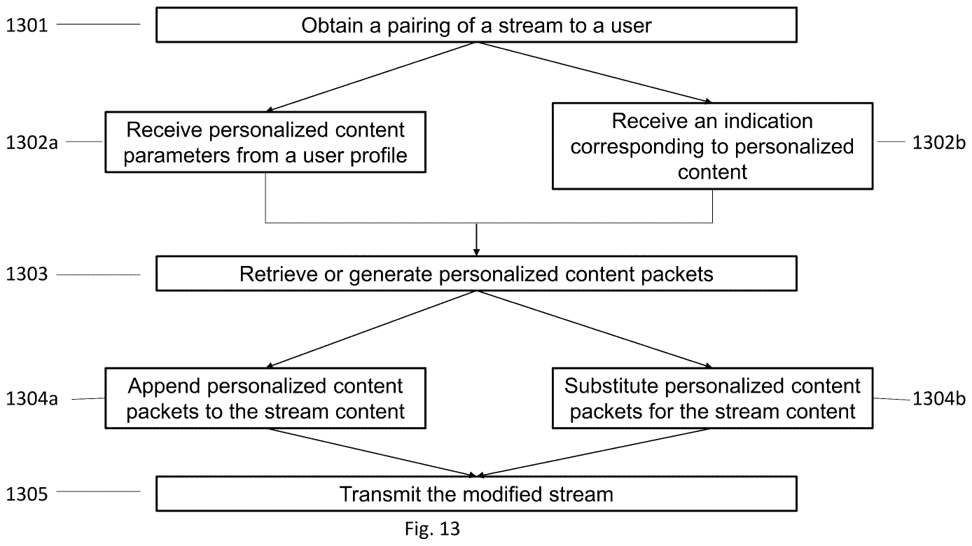

Referring now to FIG. 13, an exemplary method of personalizing content in an Over-the-Top broadcast is presented. A server obtains a pairing between a user and a stream at 1301, for example a pairing in accordance with the methods disclosed above.

The server may now personalize the content of a stream according to one or more scenarios. At step 1302a, the server may receive parameters associated with the user's personalized content from a memory, for example from a user profile, a user history, such as a watch history, or an interaction history. Alternatively, or concomitantly, the server may receive at step 1302b an indication corresponding to personalized content. For example, the indication may be received from a user device, such as a user device executing a companion application. The companion application may present personalization options to the user, for example options to remove advertisements, skip certain content of the stream, substitute or append content. For example, the companion application may present the user with the option of requesting actor/director/producer biographies, videos of critic reviews or “making of” video content. It will be understood that the personalization options discussed above may also be stored as user preferences, a user profile or as another type of data structure retrieved automatically by a server upon obtaining a pairing. Upon the user choosing a personalization option, the server receives the indication corresponding to the personalization option.

At step 1303, having received personalization parameters, for example by retrieving such parameters from a memory or a database, or by receiving an indication corresponding to such parameters, the server retrieves content packages or segments corresponding to the personalized content parameters. The personalized content segments may be stored in a memory, for example if the personalized content is a biography, a critic review or a “making of” video. The personalized content segments may be generated dynamically, or be a combination of content retrieved from a memory and dynamically generated content, for example when the personalized content is interactive in response to indications by one or a plurality of users. For example, the personalized content may be a survey or a trivia quiz. The server may retrieve content associated with the questions from a memory and dynamically generate response bar charts showing the answer distribution across a plurality of users.

Upon retrieving or generating personalized content packets, the server may modify the content of the stream in accordance with user preferences or with predetermined algorithms, for example in accordance with a default preference to substitute. When a server appends content packets to a stream content at step 1304a, the overall duration of the stream is extended. For example, in a nonlinear broadcast, a user may indicate or store in a profile a preference for seeing “making of” content before an episode of a show. Accordingly, a server may append video content outlining events, challenges or actor impressions from filming a given episode prior to providing the episode in the stream.

The server may also substitute personalized content segments for existing stream segments at step 1304b. For example, in a linear broadcast, such as a live sporting event, a user may indicate or store a preference for a particular view, for example a centre-ice view for hockey games. Personalized content segments may comprise segments recorded or provided by cameras positioned at a centre-ice view. When such content is available, the server personalizes the stream by substituting centre-ice-view segments for existing segments of the hockey game stream. In other types of broadcasts, including nonlinear broadcasts, the server may replace advertising content packets with news content packets.

The paired stream modified in accordance with the user preference, or the user indication is then transmitted at step 1305.

The methods disclosed herein may be implemented to provide interactive content. For example, the server may cooperate with the user device, for example by showing additional content on a companion app. The server may store a log of all ads and content played, with means to cause the replay or the viewing of such content, for example by providing said log on a companion app on the user device with clickable links.

The server may be configured to provide the user, for example through the user device, with the option to buy tickets to events, for example by appending content upcoming local show times to a concert stream, and causing a user device, for example through the companion app, to prompt the user to purchase a ticket to an upcoming local show. The user may indicate or store a preference for premium content. The server may be configured to, accordingly, modify the stream content to include the premium content. If the server is not configured with the credentials to access the premium content, for example by having the user's valid log-in details, the server may modify the stream to prompt the user for said credentials or to purchase a premium subscription. The server may also cause the user device to display the same prompt, or provide the user with additional content associated with the content of the stream, for example a convenient payment page.

The server may be configured to retrieve social media content associated with the stream content, for example Twitter discussions, and to append, substitute or otherwise modify content packets of the stream to provide the social media content to the user, such as through an overlay.

Other interactivity implementations are possible. Without limitation, such interactivity implementations may include making content suggestions to the user, showing product information, displaying a stream on the companion app, previewing content, directly controlling the experience, playing assets or playlists on demand, with or without a queue, skipping or banning assets, fast-forwarding or restarting an asset, choosing a different audio track or video point of view, tweaking the experience through preferences.

For example, the user may pick a different video experience to accompany an audio experience, for instance by choosing between showing news, visualizers, trivia, lyrics, ambiance or weather on a music channel. Conversely, the user may personalize a stream by pick an audio experience to accompany a video experience, for example by choosing whether to have music or not on a slow tv channel, or to have lead vocals or not on a karaoke channel. The user may also personalize the experience by adding a video overlay, such as a newsfeed or weather information displayed at the bottom of the screen.

It will be understood that personalization parameters such as user preferences may be persistent, for example by being stored in non-transitory memory such as a database. The memory may be comprised within the one or more servers implementing the methods described herein, or be otherwise stored, for example in cloud storage. A user may create a persistent preference akin to managing a channel's content, for example by creating a preference to show more sunrise ambiance assets each Monday. Accordingly, user preferences may comprise a partial or full content schedule for a stream. User preferences and user data may be stored on the user device and accessed by or transmitted to the server as needed, for example through a companion app.

It will be understood that upon obtaining a pairing at step 1301, a server may carry out steps 1302-1305 automatically without the user needing to take any action. For example, a user preference may comprise an instruction to skip certain content, for example mature content, and/or to insert content tailored to the user.

In some examples, a stream's content may be fine-tuned by selecting content according to sub-genres. For example, on a Rock channel, a user may indicate or store a preference for Classic Rock, Soft Rock, Hard Rock, Progressive Rock, etc.

In some examples, the server may be configured to modify the stream content by integrating personalized content into existing content, for example through a picture-in-picture method. Accordingly, a server may integrate personalized content segments into a stream by overlaying the personalized content over the stream content.

It will be understood that the methods disclosed herein are also suitable for personalizing advertisements to a user, for example by using a mobile advertisement ID (e.g., IDFA) for advertisement insertion into the stream or into the personalized content. Accordingly, a paired stream may comprise a plurality of personalized contents, for example additional content before a show episode and personalized and/or tailored advertisements.

The techniques and methods discussed herein permit personalization of a stream without re-encoding each stream being transmitted, especially when it comes to video. This advantage may scale, for example a single encoding may be re-used, each stream may be encoded, or a combination may be used, i.e., multiple encodings may be re-used.

The methods of the present disclosure may be implemented on a system configured to execute instructions suitable for achieving the user pairing and content personalisation described herein. For example, a system may comprise computer-readable non-transient memory, the memory comprising instructions. A processor or a plurality of processors may be operatively connected to the memory and configured, when executing the instructions comprised in the memory, to execute the pairing steps described above, the content personalization steps described above, or a combination thereof. The system may comprise a plurality of memories, transient and non-transient. For example, a transient memory may be configured to store an association between a stream and a unique identifier when the system is not in persistent pairing mode. Once no pairings are in progress, the association may be erased from the transient memory. If the system is configured to be in persistent pairing mode, a non-transient memory may store a persistent association between unique identifiers and streams for re-use during multiple pairings. In other examples, a transient memory may temporarily store associations between unique identifiers and streams, allowing the same unique identifier to be re-used across several streams over time without generating or storing lengthy association schedules.

The system may comprise other memories, for example non-transient memories comprising user profiles, user preferences and personalized content.

It will be understood that the systems described herein possess means to receive and send signals and data required to implement the methods described above, according to many acceptable transmission protocols, including wired and wireless transmissions. All means of communicating and receiving data from the systems described above are intended to fall within the scope of the present disclosure.

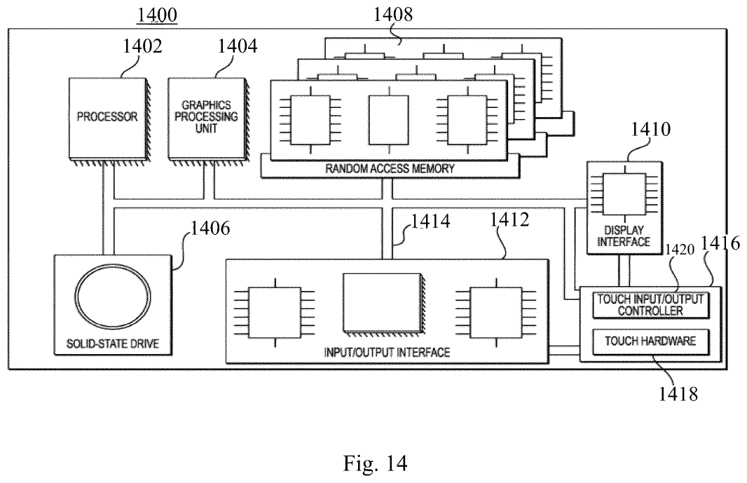

Referring to FIG. 14, there is shown an exemplary electronic device 1400 suitable for use with some implementations of the present technology as a server and/or a user device for example, the electronic device 1400 comprising various hardware components including one or more single or multi-core processors collectively represented by processor 1402, a graphics processing unit (GPU) 1404, a solid-state drive 1406, a random access memory 1408, a display interface 1410, and/or an input/output interface 1412.

Communication between the various components of the electronic device 1400 may be enabled by one or more internal and/or external buses 1414 (e.g., a PCI bus, universal serial bus, IEEE 1394 “Firewire” bus, SCSI bus, Serial-ATA bus, etc.), to which the various hardware components are electronically coupled.

The input/output interface 1412 may be coupled to a touchscreen 1416 and/or to the one or more internal and/or external buses 1414. The touchscreen 1416 may be part of the display. In one or more embodiments, the touchscreen 1416 is the display. The touchscreen 1416 may equally be referred to as a screen 1416. In the embodiments illustrated in FIG. 14, the touchscreen 1416 comprises touch hardware 1418 (e.g., pressure-sensitive cells embedded in a layer of a display allowing detection of a physical interaction between a user and the display) and a touch input/output controller 1420 allowing communication with the display interface 1410 and/or the one or more internal and/or external buses 1414. In one or more embodiments, the input/output interface 1412 may be connected to a keyboard (not shown), a mouse (not shown) or a trackpad (not shown) allowing the user to interact with the electronic device 1400 in addition or in replacement of the touchscreen 1416.

According to implementations of the present technology, the solid-state drive 1406 stores program instructions suitable for being loaded into the random-access memory 1408 and executed by the processor 1402 and/or the GPU 1404 for monitoring audio signals. For example, the program instructions may be part of a library or an application.

The electronic device 1400 may be implemented as a server, a desktop computer, a laptop computer, a tablet, a smartphone, a personal digital assistant, or any device that may be configured to implement the present technology, as it may be understood by a person skilled in the art.

The embodiments of the technology described above are intended to be exemplary only. The scope of the present technology is therefore intended to be limited solely by the scope of the appended claims.

1-44. (canceled)

45. A method for pairing a user to a display device in an Over-The-Top broadcasting system, the method being executed by a processor, the method comprising:
embedding unique identifiers into a plurality of streams, each one of the plurality of streams being associated with a respective one of the unique identifiers and with a respective one of a plurality of display devices;
transmitting the plurality of streams to a plurality of display devices, each one of the plurality of streams being transmitted to a respective one of the plurality of display devices;
receiving from a user device an indication of a given one of the unique identifiers;
assigning a given one of the plurality of display devices that is associated with the given one of the unique identifiers to the user, thereby obtaining a pairing between the user and the given one of the plurality of display devices; and
outputting the pairing.

46. The method of claim 45, wherein said each one of the plurality of streams is associated with the respective one of the unique identifiers and with the respective one of a plurality of display devices at a given time, and the given one of the plurality of display devices further corresponds to the given time at which the given one of the unique identifiers had been embedded into a respective one of the plurality of streams.

47. The method according to claim 45, further comprising:
generating personalized content for the user;
embedding the personalized content into the given one of the plurality of streams, thereby obtaining a personalized stream;
transmitting the personalized stream to the given one of the plurality of display devices that is associated with the given one of the unique identifiers.

48. The method according to claim 45, further comprising receiving a pairing request from the user device.

49. The method according to claim 45, wherein the unique identifiers comprise one of barcodes, QR-codes, images, numbers, alphanumeric codes and sounds.

50. The method according to claim 47, wherein said generating personalized content comprises retrieving the personalized content associated with the user from a database.

51. The method according to claim 47, wherein said generating personalized content comprises receiving, from the user device, an indication of predetermined content to be embedded in the given one of the plurality of streams.

52. The method according to claim 47, wherein said embedding comprises replacing at least a portion of a content of the given one of the plurality of streams with the personalized content.

53. The method according to claim 52, wherein the at least a portion of the content is one of predetermined and arbitrary.

54. The method according to claim 47, wherein said embedding comprises inserting the personalized content between at least two portions of a content of the given one of the plurality of streams.

55. A system for pairing a user to a display device in an Over-The-Top broadcasting system, the system comprising:
a processor;
a non-transitory storage medium operatively connected to the processor, the non-transitory storage medium comprising computer-readable instructions;
the processor, upon executing the instructions, being configured for:
embedding unique identifiers into a plurality of streams, each one of the plurality of streams being associated with a respective one of the unique identifiers and with a respective one of a plurality of display devices;
transmitting the plurality of streams to a plurality of display devices, each one of the plurality of streams being transmitted to a respective one of the plurality of display devices;
receiving from a user device an indication of a given one of the unique identifiers;
assigning a given one of the plurality of display devices that is associated with the given one of the unique identifiers to the user, thereby obtaining a pairing between the user and the given one of the plurality of display devices; and
outputting the pairing.

56. The system of claim 55, wherein said each one of the plurality of streams is associated with the respective one of the unique identifiers and with the respective one of a plurality of display devices at a given time, and the given one of the plurality of display devices further corresponds to the given time at which the given one of the unique identifiers had been embedded into a respective one of the plurality of streams.

57. The system according to claim 55, wherein the processor is further configured for:
generating personalized content for the user;
embedding the personalized content into the given one of the plurality of streams, thereby obtaining a personalized stream;
transmitting the personalized stream to the given one of the plurality of display devices that is associated with the given one of the unique identifiers.

58. The system according to claim 55, wherein the processor is further configured for receiving a pairing request from the user device.

59. The system according to claim 55, wherein the unique identifiers comprise one of barcodes, QR-codes, images, numbers, alphanumeric codes and sounds.

60. The system according to claim 57, wherein said generating personalized content comprises retrieving the personalized content associated with the user from a database.

61. The system according to claim 57, wherein said generating personalized content comprises receiving, from the user device, an indication of predetermined content to be embedded in the given one of the plurality of streams.

62. The system according to claim 57, wherein said embedding comprises replacing at least a portion of a content of the given one of the plurality of streams with the personalized content.

63. The system according to claim 62, wherein the at least a portion of the content is one of predetermined and arbitrary.

64. The system according to claim 67, wherein said embedding comprises inserting the personalized content between at least two portions of a content of the given one of the plurality of streams.
